(19) United States
(12) Patent Application Publication
(10) Pub. No.: US 2015/0119313 A1
(43) Pub. Date: Apr. 30, 2015

(54) UNIVERSAL POLISHING SOLUTIONS

(71) Applicant: Michael Connelly, Sterling Heights, MI (US)

(72) Inventor: Michael Connelly, Sterling Heights, MI (US)

(21) Appl. No.: 14/530,674

(22) Filed: Oct. 31, 2014

Related U.S. Application Data
(60) Provisional application No. 61/898,271, filed on Oct. 31, 2013.
(60) Provisional application No. 61/898,286, filed on Oct. 31, 2013.

(51) Int. Cl. C11D 17/00; C11D 11/00; C11D 1/29

(52) U.S. Cl. CPC C11D 17/0008; C11D 1/29; C11D 11/0023; C11D 11/0047
USPC 510/426; 510/405

(57) ABSTRACT

A liquid solution for polishing has been discovered which is particularly effective on smooth, solid surfaces. The solution may be embodied as a concentrate that is dissolved in water, which consist of, by volume at room temperature, 9.375 percent wax enhancer, 0.782 percent polydimethlsiloxanne solution, 15.625 percent methanol-propylene glycol, 0.132 percent anionic surfactant, and 70.31 percent water. Various ranges of concentrations for the composition components have been discovered, and the concentration ranges featuring various advantages and disadvantages are disclosed herein. The composition may be applied to various surfaces to be polished in a number of ways as disclosed herein.

### CLAIMS OF PRIORITY

The invention is a utility patent application based on and claims priority from co-pending U.S. Provisional Application No. 61/898,271 entitled GLASS AND AUTO POLISH as well as U.S. Provisional Application No. 61/898,286 entitled TOUCH SCREEN SOLUTION, both filed on Oct. 31, 2013 and having common inventor Michael Connelly, and both of which are incorporated by reference herein in their entirety.

### TECHNICAL FIELD OF THE INVENTION

The invention relates generally to cleaning supplies.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

People have long struggled to quickly and effectively clean glass and automobile surfaces. Additionally, since the advent of computer/handheld screen having significant video definition, users have struggled to quickly and effectively clean the surfaces of their devices, and in the case of touch-screen devices, to clean the device(s) in a manner that resists fingerprints. Ammonia-based products such as Windex® streak, while water is not a sufficiently effective solvent. Additionally, even if these products do “clean” a surface, the surface is often soon-after soiled by dirt, grime, oils, or other contaminants. Accordingly, there are needed systems and devices that help to both clean a surface, as well as coat the surface in such a way as to make it more easy to re-clean with just a wipe of a cloth at a later time. The present invention provides such a cleaning solution.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “attaching” may be done by hook-and-loop attachment (such as Velcro®), snaps, hooks, belts, etc., and so a use of the word attaching invokes all methods of attachment known in and anticipated by the art, and all other modes of that word and similar words).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for —functioning—” or “step for —functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given their plain, ordinary meaning, unless indicated otherwise.

It should be noted in the following discussion that acts with like names are performed in like manners, unless otherwise stated. Of course, the foregoing discussions and definitions are provided for clarification purposes and are not limiting. The numerous innovative teachings of present application are described with particular reference to presently preferred embodiments.

### DESCRIPTION OF THE INVENTION

### General Purpose Auto Polish

In one embodiment the invention is a glass and general-purpose auto polish (“the polish”). The present discussion pre-supposes the creation of a single U.S. Gallon of the polish (all measurements are in U.S. standard units).

The inventive polish comprises a wax enhancer, such as wax enhancer #797 in a quantity ranging between 8 and 12 ounces, such as 9 to 11 ounces, and preferably 10 ounces. Of course, other wax enhancers and quantities of such are readily apparent to those of ordinary skill in the art upon reading this disclosure.

The inventive polish also comprises a shine chemical having butyl acetate or polydimethylsiloxanne, such as “GR8 Shine!” water-based tire dressing, in a quantity ranging between 3 and 5 ounces, such as 3.5 to 4.5 ounces, and preferably 4 ounces. Of course, other shine-creating chemicals and quantities of such are readily apparent to those of ordinary skill in the art upon reading this disclosure.

The inventive polish additionally comprises a windshield solvent, such as methanol or propylene glycol, in a quantity ranging between 10 and 14 ounces, such as 11 to 13 ounces, and preferably 12 ounces. Of course, other windshield solvents and quantities of such are readily apparent to those of ordinary skill in the art upon reading this disclosure.

The inventive polish comprises a denatured alcohol, such as ethyl alcohol, methanol, or methyl isobutyl keytone, in a quantity ranging between 6 and 10 ounces, such as 7 to 9 ounces, and preferably 8 ounces. Of course, other denatured alcohols and quantities of such are readily apparent to those of ordinary skill in the art upon reading this disclosure.

The inventive polish comprises a anionic surfactant, such as sodium laureth sulfate, or sodium lauryl sulfate, in a quantity ranging between 1 and 7 ml, such as 2 to 6 ml, and preferably between 2.5-5 ml, such as 4 ml. Of course, other wax enhancers and quantities of such are readily apparent to those of ordinary skill in the art upon reading this disclosure.

The remainder of the Gallon of polish is water, and while tap water and mineral water are usable, the water is preferably distilled or filtered water.

### General Purpose Polish for Touch Screens

In one embodiment the invention is a screen polish for computer monitors and hand-held devices (“the polish”). The present discussion pre-supposes the creation of a single U.S. Gallon of the polish (all measurements are in U.S. standard units).

The inventive polish comprises a wax enhancer, such as wax enhancer #797 in a quantity ranging between 3 and 5 ounces, such as 3.5 to 4.5 ounces, and preferably 4 ounces. Of course, other wax enhancers and quantities of such are readily apparent to those of ordinary skill in the art upon reading this disclosure.

The inventive polish also comprises a shine chemical having butyl acetate or polydimethylsiloxanne, such as “GR8 Shine!” water-based tire dressing in a quantity ranging between 1 and 3 ounces, such as 1.5 to 2.5 ounces, and preferably 2 ounces. Of course, other shine-creating chemicals and quantities of such are readily apparent to those of ordinary skill in the art upon reading this disclosure.

The inventive polish additionally comprises a windshield solvent, such as methanol or propylene glycol, in a quantity ranging between 10 and 14 ounces, such as 11 to 13 ounces, and preferably 12 ounces. Of course, other windshield solvents and quantities of such are readily apparent to those of ordinary skill in the art upon reading this disclosure.

The inventive polish comprises a denatured alcohol, such as ethyl alcohol, methanol (preferred), or methyl isobutyl keytone, in a quantity ranging between 8 and 12 ounces, such as 9 to 11 ounces, and preferably 10 ounces. Of course, other denatured alcohols and quantities of such are readily apparent to those of ordinary skill in the art upon reading this disclosure.

The inventive polish comprises an anionic surfactant, such as sodium laureth sulfate, or sodium lauryl sulfate, in a quantity ranging between 1 and 7 ml, such as 2 to 6 ml, and preferably between 2.5-5 ml, such as 4 ml. Of course, other wax enhancers and quantities of such are readily apparent to those of ordinary skill in the art upon reading this disclosure.

The remainder of the Gallon of polish is water, and while tap water and mineral water are usable, the water is preferably distilled or filtered water.

### Universal Purpose Embodiment

In one embodiment the invention is a screen polish having universal applicability (“the polish”). The present discussion pre-supposes the creation of a single U.S. Gallon of the polish (all measurements are in U.S. standard units).

The inventive polish comprises a wax enhancer, such as wax enhancer #797 in a quantity ranging between 10 and 12 ounces, such as 10.5 to 11.5 ounces, and preferably 12 ounces. Of course, other wax enhancers and quantities of such are readily apparent to those of ordinary skill in the art upon reading this disclosure.

The inventive polish also comprises a shine chemical having butyl acetate or polydimethylsiloxanne, such as “GR8 Shine!” water-based tire dressing, in a quantity ranging between 1 and 4 ounces, such as 2 to 3 ounces, and preferably 1 ounce. Of course, other shine-creating chemicals and quantities of such are readily apparent to those of ordinary skill in the art upon reading this disclosure.

The inventive polish comprises an anionic surfactant, such as sodium laureth sulfate, or sodium lauryl sulfate, in a quantity ranging between 1 and 7 ml, such as 2 to 6 ml, and preferably between 2.5-5 ml, and more preferably still 5 ml. Of course, other wax enhancers and quantities of such are readily apparent to those of ordinary skill in the art upon reading this disclosure.

Further and optionally, for certain cold-weather applications, such as in an automobile and window applications, cold-resistance properties may be obtained by adding a methanol-propylene glycol mix. Accordingly, the mix may be in a quantity ranging between 10 and 20 ounces, such as 14 to 16 ounces, and preferably 20 ounces. In one embodiment, the mix is added via a proportion value to create a concentrate measured by an hydrometer to a reading of between 32 F. and −36 F., with a preferred reading of −23 F. during cold months and 12 F. during warm months. Of course, other windshield solvents and quantities of such are readily apparent to those of ordinary skill in the art upon reading this disclosure. The remainder of the Gallon of polish is water, and while tap water and mineral water are usable, the water is preferably distilled or filtered water.

Accordingly, the solution may be embodied as a concentrate that is dissolved in water, which consist of, prefereably, by volume at room temperature, 9.375 percent wax enhancer, 0.782 percent polydimethlsiloxanne solution, 15.625 percent methanol-propylene glycol, 0.132 percent anionic surfactant, and 70.31 percent water. Similar volumetric percentages may be calculated for the above-referenced room temperature volume by ounces measurements.

Furthermore, although the invention has been described with respect to a specific preferred embodiment, many variations and modifications, including equivalents, will become apparent to those skilled in the art upon reading the present application. It is therefore the intention that the appended claims and their equivalents be interpreted as broadly as possible in view of the prior art to include all such variations and modifications.

I claim:

1. A liquid polishing composition, consisting of:
between about ten ounces and about twelve ounces by volume of a wax enhancer;
between about one ounce and about four ounces by volume of a shine chemical;
between about one milliliter and about seven milliliters by volume of an anionic surfactant; and
water such that the total volume of the composition is approximately 128 ounces.

2. The liquid polishing composition of claim 1 wherein:
said wax enhancer is present in a volume of between about ten and one-half ounces and about eleven and one-half ounces;
said shine chemical is present in a volume of between about two ounces and about three ounces; and
said anionic surfactant is present in a volume of between about two milliliters and about six milliliters.

3. The liquid polishing composition of claim 2 wherein:
said wax enhancer is present in a volume of about twelve ounces;
said shine chemical is present in a volume of about one ounce; and
said anionic surfactant is present in a volume of about three milliliters.

4. The liquid polishing composition of claim 1 wherein the wax enhancer is preferably wax enhancer formulation standard industrialized number seven hundred and ninety seven.

5. The liquid polishing composition of claim 1 wherein the shine chemical comprises butyl acetate.

6. The liquid polishing composition of claim 1 wherein the shine chemical comprises polydimethylsiloxanne.

7. The liquid polishing composition of claim 1 wherein the anionic surfacant comprises sodium laureth sulfate.

8. The liquid polishing composition of claim 1 wherein the anionic surfacant comprises sodium lauryl sulfate.

9. The liquid polishing composition of claim 1 further comprising methanol.

10. The liquid polishing composition of claim 1 further comprising propylene glycol.

11. The liquid polishing composition of claim 1 further comprising by liquid volume between about ten ounces and about twenty ounces of a methanol-propylene glycol mix.

12. The liquid polishing composition of claim 12 wherein the methanol-propylene glycol mix is present in a liquid volume of between about fourteen ounces and about sixteen ounces.

13. The liquid polishing composition of claim 12 wherein the methanol-propylene glycol mix is present in a liquid volume of about twenty ounces.

14. The liquid polishing composition of claim 12 wherein the methanol-propylene glycol mix is present in a liquid volume sufficient to cause a hydrometer to read that the composition will remain a liquid at negative thirty six degrees Fahrenheit.

15. A liquid polishing composition, comprising:
about 9.375 percent by volume of a wax enhancer;
about 0.782 percent by volume of a shine chemical;
about 0.132 percent by volume of an anionic surfactant; and
about 89.71 percent by volume of water.

16. A liquid polishing composition, comprising:
about 9.375 percent by volume of a wax enhancer;
about 0.782 percent by volume of a shine chemical;
about 0.132 percent by volume of an anionic surfactant;
about 15.625 percent by volume of an antifreeze comprising propylene glycol; and
about 74.086 percent by volume of water.
